(19) United States
(12) Patent Application Publication
(10) Pub. No.: US 2013/0302118 A1
(43) Pub. Date: Nov. 14, 2013

(54) METHOD FOR HANDLING BAGGAGE WITHIN AIRPORT AND SYSTEM THEREOF

(71) Applicant: Gerhard Josef Kleber, Beijing (CN)

(72) Inventor: Gerhard Josef Kleber, Beijing (CN)

(73) Assignee: Siemens Aktiengesellschaft, Munich (DE)

(21) Appl. No.: 13/981,000

(22) PCT Filed: Jan. 21, 2011
(86) PCT No.: PCT/CN11/70494

§ 371 Date: Jul. 22, 2013

(51) Int. Cl. B65G 67/04; B65G 67/24; B60P 1/00

(52) U.S. Cl. CPC B65G 67/04; B60P 1/00; B65G 67/24
USPC 414/390; 414/809; 414/572; 414/398; 414/507

(57) ABSTRACT

A method for handling baggage inside an airport, a baggage handling system inside an airport, a transfer system and a transport system. A device loads sorted bags into a vehicle at a first location. The vehicle is configured to transport passengers from the first location to a second location. The vehicle transports the bags with the passengers from the first location to the second location. In this way, bags can be transported with a vehicle formerly for transporting passengers.

### FIELD OF THE INVENTION

The present invention relates to infrastructure logistics, and particularly relates to a method for handling baggage inside an airport, a baggage handling system inside an airport, a transfer system and a transport system.

### BACKGROUND OF THE INVENTION

Airports usually cover a wide area, and have many types of buildings inside, which depends on the configuration of the airports. A terminal is a building at an airport where passengers transfer between ground transportation and the facilities that allow them to board and disembark from aircraft. Smaller airports have one terminal while larger airports have several terminals and/or concourses. The buildings that provide access to aircrafts (or airplanes) via gates are typically called concourses. Some larger airports have one terminal that is connected to multiple concourses via walkways or sky-bridges. Some larger airports have more than one terminal, each with one or more concourses. A satellite is a building detached from other airport buildings such as a terminal, so that aircraft can park around its entire circumference.

Inside the airport, people and goods in one place should be able to reach another place quickly and without burdening resources. An automated people mover (APM), which is a fully automated, grade-separated mass transit system, is therefore an extremely suitable form of passenger transportation within the airport, for example from one terminal to another terminal. As to bags (or luggage), they may be transported via separate underground tunnels specifically.

FIG. 1 is a flowchart illustrating an existing transportation of baggage. At step 101, multiple bags (or baggage pieces) are received from check-in counters of Terminal A. Security check and sortation for the bags are performed at steps 102 and 103, respectively. It should be pointed out that a baggage handling system can sort a bag automatically once it has scanned the bar code on the bag tag which contains the flight details and passenger information. At step 104, the bags are automatically loaded to trays or a belt system built in a tunnel. Then, the bags are transported to another terminal or satellite (for example, Terminal B) at step 105. Thereafter, at steps 106 and 107, another sorting in trays is performed and the bags are automatically unloaded from trays in Terminal B. At steps 108 and 109, the bags are loaded to dollies or containers and finally put into an aircraft.

That is, people and baggage are transported separately in the existing art. People can move via an automated people mover within the airport while baggage is transported via a baggage line in a tunnel.

### SUMMARY OF THE INVENTION

The present invention provides a method for handling baggage within an airport, including: loading sorted bags into a vehicle at a first place, the vehicle being adapted to transport passengers from the first place to a second place; transporting, by the vehicle, the bags with the passengers from the first place to the second place. Preferably, the first place and the second place are different terminals or satellites in the airport.

With this solution, after sortation, the bags are only transferred for a very short distance via a conventional art, such as a belt or tray system within a terminal/satellite, and then transported with passengers by a vehicle, such as a train or an automated people mover (APM) or a bus, from the terminal/satellite to another terminal/satellite. In this case, there is no need to build a separate tunnel in the airport for the baggage transport between terminals, and there is no need to wait the bags for a long time at another terminal as the passengers and bags may be transported together by a high-speed train or an APM.

According to an embodiment of the present invention, after sortation, instead of individual handling of baggage pieces, the bags are fed into containers and then the containers are loaded into the train or APM and transported by the train or APM from a terminal/satellite to another. In this way, it is possible to unload a container from the train or APM at another terminal/satellite and to convey it directly onto its target aircraft. That is, a container having multiple bags inside is a basic unit during baggage loading into a vehicle or baggage unloading off the vehicle.

The present invention also provides a baggage handling system in an airport, including: a loading device, adapted to load sorted bags into a vehicle at a first place, the vehicle being adapted to transport passengers from the first place to a second place; wherein the bags are transported with the passengers by the vehicle from the first place to the second place.

The present invention also provides a transfer system in an airport, including: a vehicle, adapted to transport passengers and bags together from a first place to a second place in the airport; and the baggage handling system.

The present invention also provides a transport system, including: an automated people mover including one or more passenger carriages adapted to carry passengers and one or more baggage carriages adapted to carry bags; wherein each of the one or more baggage carriages is equipped with a conveyor.

### BRIEF DESCRIPTION OF DRAWINGS

FIG. 1 is a flowchart illustrating an existing transportation of baggage;

FIG. 2 is a flowchart illustrating transportation of baggage according to an embodiment of the present invention;

FIG. 3 is a schematic diagram illustrating a transfer system according to an embodiment of the present invention;

FIG. 4 is a schematic diagram illustrating connection between a vehicle and a loading/unloading device according to an embodiment of the present invention.

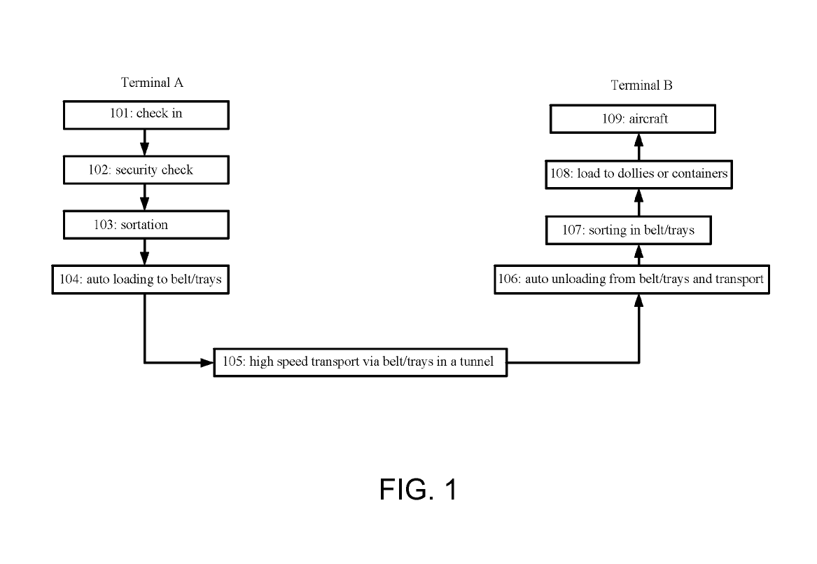

### DETAILED DESCRIPTION OF THE INVENTION

In the present invention, bags are fed into a baggage handling system, run through the automatic security screening if needed, transported from a first place to a second place within the airport by a vehicle formerly used for transporting passengers, and are loaded onto aircrafts (or airplanes) flying to particular destination airports. That is, people and baggage are moved at the same time via the vehicle. The vehicle's baggage carriage is equipped with a conveyor to take the bags from a station to the vehicle or unload the bags off the vehicle. A loading device on the station platform feeds the bags into a container, and automatically loads the container through a door into the baggage carriage. Baggage loading is extremely quick, so passengers boarding the vehicle do not have to wait. Accordingly, the present invention can improve baggage turn around time from a first place to a second place within an airport and vice versa, shorten waiting time for passengers, and offer passengers the perfect stress free travel experience.

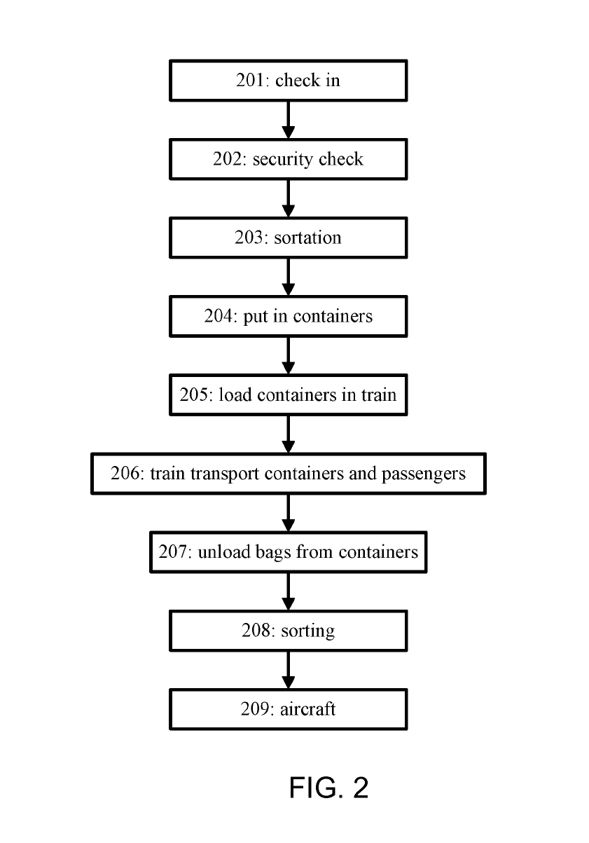

FIG. 2 is a flowchart illustrating transportation of baggage according to an embodiment of the present invention.

At steps 201-203, multiple bags are received from such as check-in counters of Terminal A, and security check and sortation for the bags are performed, respectively. At step 204, according to sortation result, the bags to be transferred to the Terminal B are put in containers. For example, bags belonging to flight A are filled into container 1, while bags belonging to flight B are filled into container 2, wherein the flights A and B will take off from the Terminal B. The bags may also been put into containers randomly without any further sortation for flights. At step 205, the containers are loaded into a vehicle (such as a train or a bus or an automated people mover). Then, the vehicle will take both containers and passengers from Terminal A to Terminal B (i.e., step 206). At step 207, bags are unloaded from containers. Optionally, at steps 208 and 209, the bags are sorted again according to their target flights and sent to a corresponding aircraft. When aircraft ULDs are used as the container in the vehicle, it is possible to unload the container from the vehicle and to convey it directly onto its aircraft without further individual handling of the baggage pieces. In an example, the vehicle has cyclicity for baggage throughput, i.e., first from Terminal A to Terminal B, and then turn back from Terminal B to Terminal A.

In the above described procedure, the bags may also be uninstalled from an aircraft parked in a satellite and transported via the vehicle to a baggage reclaim in a terminal. In another example, the bags may be uninstalled from an aircraft in Terminal A, and transferred to another aircraft in Terminal B.

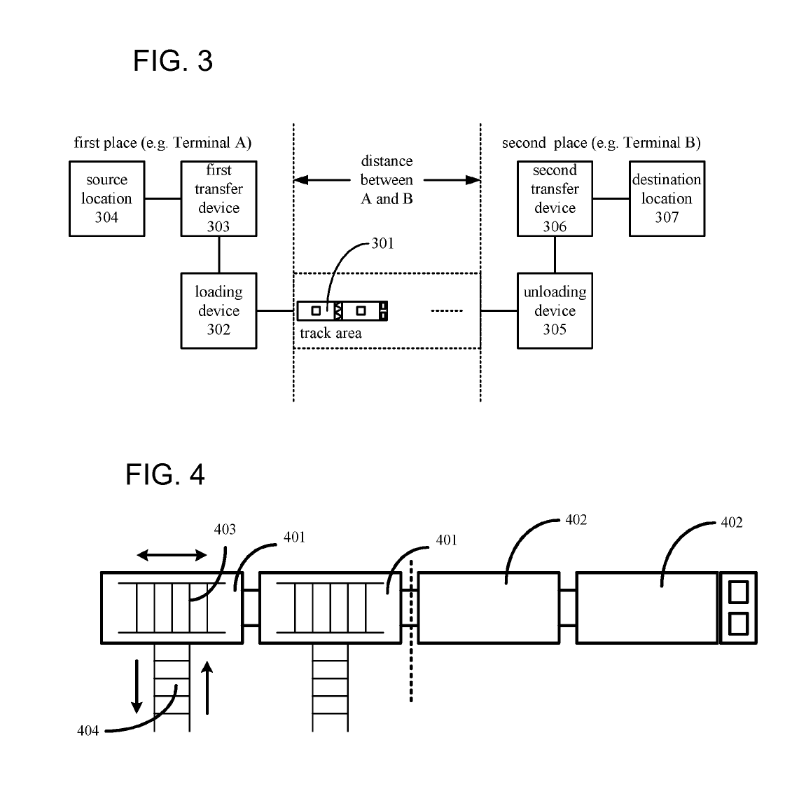

The following example provides a transfer system inside an airport. As shown in FIG. 3, the transfer system includes: a vehicle 301, adapted to transport both bags and passengers from a first place to a second place; and a baggage handling system including a loading device 302 which is adapted to automatically load the bags from a station into a space of the vehicle separated from the passengers. Here, the first place and the second place are two different places within the same airport.

In this way, an underground tunnel dedicated for transferring bags from the first place to the second place in the existing art is not needed, and a whole construction of the baggage handling system within an airport has been changed. That is, the building of separate tunnels specifically for the transport of baggage can be spared, thereby simplifying the transport of baggage inside airports, raising the speed of baggage transportation and saving the cost of airport infrastructure. Under some circumstances, the distance between the first place and the second place may be 2-3 kilometers. Transferring bags via a vehicle provided in the present invention is faster than transferring the bags through a long-distance baggage line in a tunnel.

In an embodiment, the vehicle includes: one or more passenger carriages 402, adapted to accommodate the passengers; and one or more baggage carriages 401, adapted to accommodate the bags. The baggage carriages 401 and passenger carriages 402 are, for instance, physically connected. A baggage carriage 401 is different from a passenger carriage 402 in that the passenger carriage has seats and handrails inside while the baggage carriage is optionally equipped with a second conveyor 403 for moving bags within the baggage carriage. Specifically, the vehicle can be such as a train, an automated people mover (APM) or a bus. Usually, an automated people mover is a special train with no driver, and wheels of the automated people mover are made of materials softer than steel or iron. For example, a wheel of the automated people mover is made of rubber, similar to a wheel of a car. Moreover, the automated people mover runs on a special track such as a concrete track different from a rail.

In an embodiment, the loading device includes: a first conveyor 404, adapted to load the bags into the one or more baggage carriages of the vehicle. The first conveyor may be replaced by a robot or other conveying device. In another embodiment, the loading device further includes: a sub-loading apparatus, adapted to feed the bags after security checking and/or sortation into one or more containers, which are further transferred by the first conveyor onto the vehicle. Preferably, bags for the same flight are filled into the same container when loading. Then, the first conveyor 404 is adapted to load the one or more containers into the one or more baggage carriages with the cooperation of the in-built second conveyor 403 of the corresponding baggage carriage.

Specifically, the first conveyor 404 is adapted to enable the containers waiting at the station opposite one or more loading doors corresponding to the one or more baggage carriages, and load, when the vehicle arrives at the station, the containers through the loading doors into the one or more baggage carriages 401 during boarding of the passengers into the one or more passenger carriages. Since loading of bags into a baggage carriage and boarding of passengers are implemented at the same time, passengers do not have to wait and the entire process is controlled precisely and completely automatically. Further, the second conveyor is adapted to move the bags to a suitable position inside the one or more baggage carriages. As shown in FIG. 4, the moving direction of the first conveyor during loading is perpendicular to the vehicle, thereby sending the containers into a baggage carriage of the vehicle. The moving direction of the second conveyor is along the vehicle, in order to fill the baggage carriage with the containers. For example, the length of a container matches the width of a baggage carriage and the width of the container matches that of the loading door of the baggage carriage, so that containers can be put into the baggage carriage one by one automatically.

Specifically, the container is an aircraft unit loading device (ULD) which has a shape fit with a luggage compartment of the aircraft and can be directly put into the luggage compartment. Hence, baggage transportation rate (bags per hour, bph) is further increased.

In an embodiment, the baggage handling system may further include: a first transfer device 303, adapted to transfer the bags from a source location 304 to the loading device. Here, the source location can be one of an aircraft, a check-in counter and a metro station in the airport. Before the bags are transferred via the first transfer device, security checking and/or sorting are performed for the bags.

In another embodiment, the baggage handling system may further include: an unloading device 305, adapted to automatically unload the containers off the one or more baggage carriages. Specifically, the unloading device can also be a third conveyor, wherein the moving direction of the unloading device is opposite to that of the loading device. Practically, the loading device and the unloading device can be the same device. That is, each station may equip with a conveyor for loading/unloading bags or containers. When the conveyor is used for transferring containers, the power of motors of the conveyor is higher than that for transferring bags.

Further, the baggage handling system may include: a second transfer device 306, adapted to transfer the containers unloaded by the unloading device to a destination location 307. Here, the destination location can be one of an aircraft, a baggage reclaim (e.g., carousels) and a metro station in the airport. For example, when bags for the same flight are loaded into the same container, the container can directly be put into a luggage compartment of the aircraft of the flight without further sortation.

Specifically, each of the first transfer device and the second transfer device is a belt system or a tray system or any device employed in the conventional art for transferring bags.

In practical application, the first place is in one terminal (called Terminal A hereinafter) and the second place is in another terminal (called Terminal B). For example, Terminal A is for domestic lines and Terminal B is for international lines. When there is a need for a passenger to transfer from a domestic flight in Terminal A to an international flight in Terminal B, bags from the aircraft of the domestic flight should be also transferred to corresponding aircraft of the international flight.

According to an embodiment of the present invention, bags or containers will be uninstalled from the aircraft of the domestic flight 304, sorted according to different international flights which are target flights of the bags, and sent to the first transfer device 303. Then, the first transfer device 303 will feed the bags to the loading device 302 at the first place (i.e., station 1) of Terminal A. Subsequently, the loading device 302 will put bags to be sent to the same international flight into such as container 1 and convey container 1 into a baggage carriage of the vehicle 301.

The vehicle runs along the track and stops at the second place (i.e., station 2) of Terminal B. Later on, an unloading device 305 is used to unload containers off baggage carriages of the vehicle, and provide the containers to a second transfer device 306. Finally, the second transfer device 306 will transport each of the containers or bags to a corresponding aircraft of an international flight 307.

In another practical application, the first place is one satellite and the second place is another satellite. In yet another practical application, the first place is a terminal and the second place is a satellite; or the first place is a satellite and the second place is a terminal.

Also, a transport system is provided in the present invention, which includes: an automated people mover including one or more passenger carriages adapted to carry passengers and one or more baggage carriages adapted to carry bags; wherein each of the one or more baggage carriages is equipped with a conveyor.

In another example, the transport system further includes: a concrete track laid from a first place to a second place. Here, each of the first place and the second place is one of a terminal within an airport, a satellite within an airport and a ferry port near the airport.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

1-20. (canceled)

21. A method for handling baggage within an airport, comprising:
loading, by a device, sorted bags into a vehicle at a first location within the airport, the vehicle being adapted to transport passengers from the first location to a second location within the airport; and
transporting, by the vehicle, the bags with the passengers from the first location to the second location.

22. The method according to claim 21, wherein the loading step comprises:
placing the sorted bags into one or more containers; and
conveying the one or more containers into one or more baggage carriages of the vehicle which are separated from passenger carriages of the vehicle.

23. The method according to claim 22, wherein the conveying step comprises:
enabling the containers waiting at the first location opposite one or more loading doors corresponding to the one or more baggage carriages; and
when the vehicle arrives at the first location, transferring the containers through the loading doors into the one or more baggage carriages while the passengers are boarding the passenger carriages of the vehicle.

24. The method according to claim 22, which comprises implementing the conveying step with the cooperation of a conveyor equipped within each of the baggage carriages.

25. The method according to claim 22, which further comprises automatically unloading the one or more containers off the one or more baggage carriages of the vehicle at the second location for sorting.

26. The method according to claim 25, wherein the container is an aircraft unit loading device (ULD).

27. The method according to claim 26, which further comprises transferring the ULD unloaded from the vehicle into an aircraft after sorting.

28. The method according to claim 27, wherein the vehicle is an Automated People Mover.

29. The method according to claim 21, wherein the first and second locations are selected from the group consisting of terminals and satellites, and:
the first location is one terminal and the second location is another terminal;
the first location is one satellite and the second location is another satellite;
the first location is a terminal and the second location is a satellite; or
the first location is a satellite and the second location is a terminal.

30. A baggage handling system in an airport, comprising:
a loading device configured for loading sorted bags into a vehicle at a first location in the airport, the vehicle being configured to transport passengers from the first location to a second location in the airport;
wherein the bags are transported with the passengers by the vehicle from the first location to the second location.

31. The baggage handling system according to claim 30, wherein said loading device comprises:
a sub-loading apparatus, adapted to place the sorted bags into one or more containers; and
a first conveying device, adapted to transfer the one or more containers onto one or more baggage carriages of the vehicle that are separated from the passengers.

32. The baggage handling system according to claim 31, wherein
said first conveying device is configured to enable the containers waiting at the first location opposite one or more loading doors corresponding to the one or more baggage carriages, and transfer, when the vehicle arrives at the first location, the containers through the loading doors into the one or more baggage carriages during boarding of the passengers into the vehicle.

33. The baggage handling system according to claim 32, further comprising an unloading device configured to automatically transfer the containers off the one or more baggage carriages for sorting.

34. The baggage handling system according to claim 33, wherein the container is an aircraft unit loading device (ULD).

35. The baggage handling system according to claim 33, further comprising a transfer device, adapted to transfer the unloaded containers to one of an aircraft, a baggage reclaim and a metro station in the airport, after the sorting thereof.

36. The baggage handling system according to claim 30, wherein the vehicle is a train, an automated people mover (APM) or a bus.

37. A transfer system in an airport, comprising:
a vehicle configured for transporting passengers and bags together from a first location to a second location in the airport; and
a baggage handling system according to claim 30.

38. A transport system, comprising:
an automated people mover having one or more passenger cars configured for carrying passengers and one or more baggage carriages configured to carry bags;
wherein each of said one or more baggage carriages is equipped with a conveyor.

39. The transport system according to claim 37, further comprising a concrete track laid from the first location to the second location.

40. The transport system according to claim 39, wherein the first and second locations are selected from the group consisting of a terminal within an airport, a satellite within the airport, and a ferry port near the airport.
